(19) United States
(12) Patent Application Publication
(10) Pub. No.: US 2022/0114762 A1
(43) Pub. Date: Apr. 14, 2022

(54) METHOD FOR COMPRESSING POINT CLOUD BASED ON GLOBAL MOTION PREDICTION AND COMPENSATION AND APPARATUS USING THE SAME

(71) Applicant: ELECTRONICS AND TELECOMMUNICATIONS RESEARCH INSTITUTE, Daejeon (KR)

(72) Inventors: Hyuk-Min KWON, Daejeon (KR); Jin-Young LEE, Daejeon (KR); Kyu-Heon KIM, Seoul (KR); Jun-Sik KIM, Yongin-si (KR)

(21) Appl. No.: 17/476,780

(22) Filed: Sep. 16, 2021

(30) Foreign Application Priority Data
Oct. 12, 2020 (KR) 10-2020-0131045
Feb. 5, 2021 (KR) 10-2021-0016801
Apr. 20, 2021 (KR) 10-2021-0051058
Jul. 21, 2021 (KR) 10-2021-0095687

(51) Int. Cl. G06T 9/00; G06T 7/20; G06T 7/11

(52) U.S. Cl. CPC G06T 9/00; G06T 2207/10028; G06T 7/11; G06T 7/20

(57) ABSTRACT

Disclosed herein are a method for compressing a point cloud based on global motion prediction and compensation and an apparatus for the same. The method includes receiving 3D point cloud data configured with point cloud frames that represent continuous global motion; dividing the point cloud data into point cloud data segments using a histogram generated based on the Z-axis of the point cloud data; performing a global motion search based on an occupancy map for each of the point cloud data segments; and performing motion compression for the point cloud data based on the result of the global motion search performed for each of the point cloud data segments.

### CROSS REFERENCE TO RELATED APPLICATIONS

This application claims the benefit of Korean Patent Application No. 10-2020-0131045, filed Oct. 12, 2020, No. 10-2021-0016801, filed Feb. 5, 2021, No. 10-2021-0051058, filed Apr. 20, 2021, and No. 10-2021-0095687, filed Jul. 21, 2021, which are hereby incorporated by reference in their entireties into this application.

### BACKGROUND OF THE INVENTION

### 1. Technical Field

The present invention relates generally to technology for compressing a point cloud based on global motion prediction and compensation, and more particularly to technology for efficiently compressing point cloud content by dividing objects in a point cloud and by performing global motion prediction and compensation using a motion vector in 3D, which is acquired by searching for motion between point cloud frames.

### 2. Description of Related Art

An existing 2D image is represented as a set of pixels having color values. Data represented as a set of points (voxels) having color values in three dimensions is referred to as a point cloud. Such point cloud data has characteristics in that the data pertains to more dimensions and has a greater amount than existing 2D images. Therefore, research on high-efficiency compression technology is actively underway in order to provide point cloud data to users.

The MPEG-I Part 5 Point Cloud Compression (PCC) group of MPEG, which is an international standardization organization, is working on standardization of point cloud compression technology. This compression technology may be classified into three categories depending on data characteristics. Particularly, with regard to a point cloud acquired using LiDAR, a method for compressing a point cloud using Geometry-based Point Cloud Compression (G-PCC), which uses 3D characteristics of data, is being developed.

FIG. 1 is a structure diagram illustrating an encoder 110 and a decoder 120 in G-PCC technology, research into which is being conducted by the MPEG PCC group. G-PCC is configured to compress information about the positions of points in a point cloud using an octree and a surface approximation technique and to compress attribute values using techniques such as a lifting transform, a Region Adaptive Hierarchical Transform (RAHT), and the like.

When compression is performed in consideration of the 3D characteristics of a point cloud, as described above, a high compression ratio may be expected even when a point cloud has a low density, but in order to more efficiently compress a point cloud, motion prediction and compensation techniques for interframe compression are required. To this end, the MPEG PCC group newly establishes an Exploratory Model (EM), and is researching a method for applying motion prediction and compensation techniques to compression of a point cloud acquired using LiDAR.

However, objects and roads in a point cloud acquired using a sensor, such as LiDAR or the like, have different characteristics, which makes it difficult to perform a motion search, and thus a high compression ratio is not achieved. Accordingly, high-efficiency motion prediction and compensation technology using a motion compression method depending on the characteristics of objects in a point cloud is required.

### [Documents of Related Art]

(Patent Document 1) Korean Patent Application Publication No. 10-2020-0070287, published on Jun. 17, 2020 and titled “Method for object recognition”.

### SUMMARY OF THE INVENTION

An object of the present invention is to propose high-efficiency point cloud compression technology for performing point cloud data segmentation, a global motion search, motion compensation, and the like for input point cloud data.

Another object of the present invention is to divide point cloud data acquired using a sensor, such as LiDAR or the like, into point cloud data segments depending on the characteristics thereof, to search for motion in the point cloud data segments, and to compensate the point cloud data based on a found motion vector in 3D, thereby improving the compression ratio of point cloud content.

In order to accomplish the above objects, a method for compressing a point cloud based on global motion prediction and compensation according to the present invention includes receiving 3D point cloud data configured with point cloud frames that represent continuous global motion; dividing the point cloud data into point cloud data segments using a histogram generated based on the Z-axis of the point cloud data; performing a global motion search based on an occupancy map for each of the point cloud data segments; and performing motion compression for the point cloud data based on the result of the global motion search performed for each of the point cloud data segments.

Here, dividing the point cloud data may be configured to detect the highest Z value, indicative of the largest number of points in the histogram, to calculate the gradients of the histogram from the highest Z value, and to divide the point cloud data based on a point-cloud-cutting threshold value at which gradient values equal to or less than a preset reference are continuous.

Here, performing the global motion search may include, based on the point cloud frames, projecting points in the frame, corresponding to the point cloud data segment, onto an occupancy map based on X and Y axes; and searching for motion between the point cloud frames based on the occupancy map.

Here, the result of the global motion search may be acquired so as to correspond to at least one of a motion vector or a motion transform matrix.

Here, performing the motion compression may include performing local motion compression for the point cloud data using the result of the global motion search; and performing motion information compression for the point cloud data.

Here, performing the motion information compression may be configured to compress at least one of the point-cloud-cutting threshold value and the result of the global motion search.

Here, performing the motion information compression may be configured to acquire a residual motion information matrix between the point cloud frames based on the result of the global motion search and to perform differential motion-information compression by entropy-encoding the residual motion information matrix.

Here, the method may further include performing motion compensation for each of the point cloud data segments in consideration of the local motion compression.

Here, the method may further include reconstructing point cloud data by performing motion compression for the point cloud data in reverse order.

Also, an apparatus for compressing a point cloud based on global motion prediction and compensation according to an embodiment of the present invention includes a processor for receiving 3D point cloud data configured with point cloud frames that represent continuous global motion, dividing the point cloud data into point cloud data segments using a histogram generated based on the Z-axis of the point cloud data, performing a global motion search based on an occupancy map for each of the point cloud data segments, and performing motion compression for the point cloud data based on the result of the global motion search performed for each of the point cloud data segments; and memory for storing the point cloud data.

Here, the processor may detect the highest Z-value, indicative of the largest number of points in the histogram, calculate the gradients of the histogram from the highest Z value, and divide the point cloud data based on a point-cloud-cutting threshold value at which gradient values equal to or less than a preset reference are continuous.

Here, based on the point cloud frames, the processor may project points in the frame, corresponding to the point cloud data segment, onto an occupancy map based on X and Y axes, and may search for motion between the point cloud frames based on the occupancy map.

Here, the result of the global motion search may be acquired so as to correspond to at least one of a motion vector or a motion transform matrix.

Here, the processor may perform local motion compression for the point cloud data using the result of the global motion search, and may perform motion information compression for the point cloud data.

Here, the processor may compress at least one of the point-cloud-cutting threshold value and the result of the global motion search.

Here, the processor may acquire a residual motion information matrix between the point cloud frames based on the result of the global motion search, and may perform differential motion-information compression by entropy-encoding the residual motion information matrix.

Here, the processor may perform motion compensation for each of the point cloud data segments in consideration of the local motion compression.

Here, the processor may reconstruct point cloud data by performing motion compression for the point cloud data in reverse order.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a view illustrating the structures of an encoder and a decoder of G-PCC technology, research on which is being conducted by the MPEG PCC group;

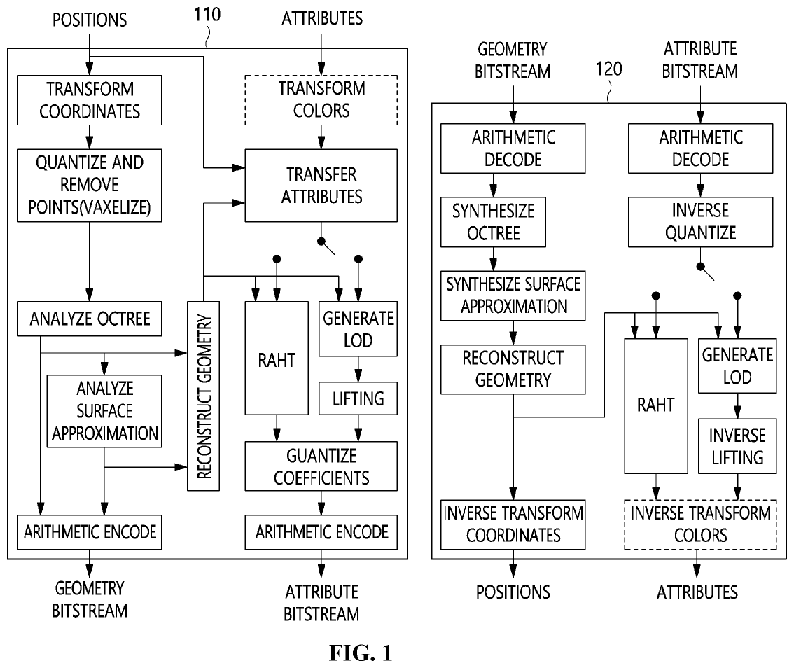

FIG. 2 is a flowchart illustrating a method for compressing a point cloud based on global motion prediction and compensation according to an embodiment of the present invention;

FIG. 3 is a view illustrating an example of a Z-axis histogram corresponding to a point cloud according to the present invention;

FIGS. 4 to 5 are views illustrating an example of global motion search and compensation based on an occupancy map according to the present invention;

FIG. 6 is a flowchart illustrating in detail a point cloud compression process according to the present invention;

FIG. 7 is a flowchart illustrating in detail an entropy-encoding-based compression process using a residual motion information matrix in the point cloud compression process illustrated in FIG. 6; and

FIG. 8 is a block diagram illustrating an apparatus for compressing a point cloud based on global motion prediction and compensation according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

In conventional global motion search methods, the distribution of points included in the entire point cloud is checked, a specific transform matrix is calculated based thereon, and motion is compensated for. However, these methods have a compression efficiency problem.

For example, a point cloud may have different characteristics depending on the method of acquiring the point cloud. When data in a point cloud relates to a single object, merely estimating the motion of the object facilitates efficient compression. However, when multiple objects are present in a point cloud or when data is acquired using a sensor, such as LiDAR or the like, the motion may be different depending on the characteristics of the objects in the point cloud.

Accordingly, in order to efficiently compress a point cloud, it is required to detect objects in the point cloud and to compress the point cloud based on the characteristics of the objects.

As an embodiment of the efficient compression of a point cloud, the present invention proposes a method for achieving high-efficiency compression by dividing a point cloud acquired using a sensor, such as LiDAR or the like, into point cloud segments depending on the characteristics of objects, by searching for motion depending on the characteristics of the point cloud segments, and by compensating the point cloud using a found motion vector.

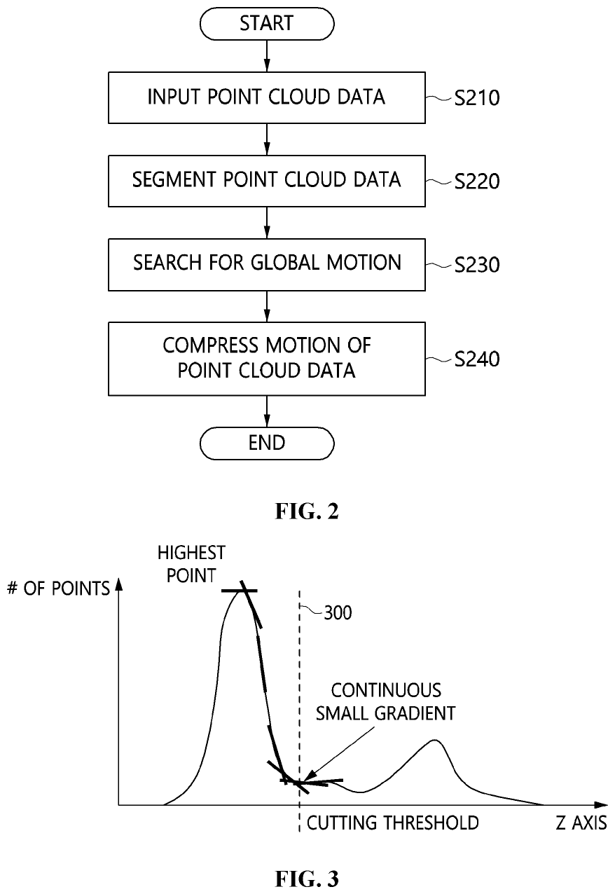

FIG. 2 is a flowchart illustrating a method for compressing a point cloud based on global motion prediction and compensation according to an embodiment of the present invention.

Referring to FIG. 2, in the method for compressing a point cloud based on global motion prediction and compensation according to an embodiment of the present invention, 3D point cloud data configured with point cloud frames that represent continuous global motion is input at step S210.

For example, the input point cloud data may be a series of 3D still images configured with point clouds. Here, all of the still images, corresponding to the respective point cloud frames representing continuous global motion, may be configured with point clouds.

Here, the point cloud data may be data acquired using a sensor, such as LiDAR or the like.

Also, in the method for compressing a point cloud based on global motion prediction and compensation according to an embodiment of the present invention, the point cloud data is segmented using a histogram generated based on the Z-axis of the point cloud data at step S220.

Here, in order to search for the global motion depending on the characteristics of the point cloud, the point cloud may be segmented.

Here, the point cloud may be segmented in a different manner depending on the characteristics of the input point cloud data. For example, in the point cloud acquired using a sensor, such as LiDAR or the like, object data pertaining to a building, a person, and the like may have characteristics that are different from the characteristics of road data. Accordingly, when the object data and the road data are separated from each other in the point cloud data, compression efficiency may be improved.

To this end, the present invention performs point cloud segmentation based on a histogram.

Here, the highest Z value, indicating the largest number of points in the histogram, is detected, the gradients of the histogram are calculated from the highest Z value, and the point cloud data may be segmented based on a point-cloud-cutting threshold value at which gradient values equal to or less than a preset reference are continuous.

For example, road data in a point cloud may have a low elevation but may be widely spread, and object data is generally located higher than the road data. That is, the road data may appear such that a large number of points corresponding thereto is distributed with low elevation values in the histogram of the point cloud, whereas the object data is perpendicular to the XY plane, is always located higher than the points corresponding to roads, and shows various changes depending on the shapes of the objects.

Accordingly, regions in which the road data and the object data are respectively distributed are detected in the Z-axis histogram, and segmentation is performed in consideration of these regions, whereby roads and objects may be separated from each other in the point cloud.

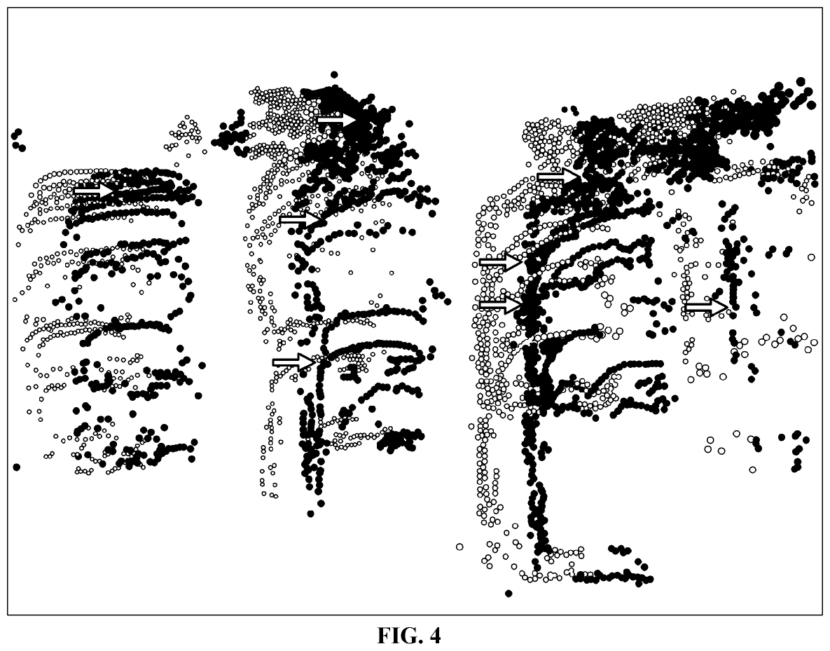

Referring to FIG. 3, first, a histogram may be generated based on the Z-axis values of points in a point cloud. Here, in order to lower the sensitivity of the histogram, the Z-axis values may be adjusted to a specific scale. Then, the highest point, indicating inclusion of the largest number of points in the Z-axis-based histogram, may be searched for. Then, the gradients of the histogram are calculated from the highest point, whereby a point-cloud-cutting threshold value 300, which is the point at which continuous small gradient values appear, may be found. Based on the found point-cloud-cutting threshold value 300, the road data and the object data may be separated from each other.

Also, in the method for compressing a point cloud based on global motion prediction and compensation according to an embodiment of the present invention, an occupancy-map-based global motion search is performed for each point cloud data segment at step S230.

Here, the global motion search may be performed depending on the characteristics of each point cloud data segment.

For example, in the case of point cloud data acquired through a vehicle, global motion of points in the point cloud may occur due to movement of the vehicle. When such global motion is found and used to compress a point cloud, the point cloud may be efficiently compressed.

To this end, the present invention performs a global motion search based on an occupancy map. The global motion search based on an occupancy map is a method in which a point cloud is transformed to an occupancy map based on the XY plane and motion is searched for based on the occupancy map.

Accordingly, based on the point cloud frames, points in the frame corresponding to the point cloud data segment may be projected onto an occupancy map based on the X-axis and the Y-axis.

Here, the motion between the point cloud frames may be searched for based on the occupancy map.

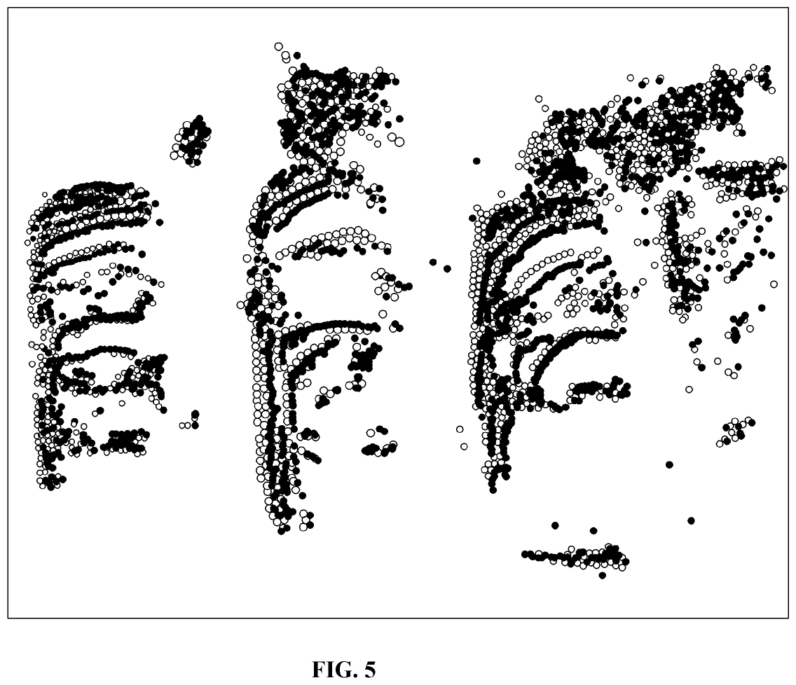

For example, referring to FIG. 4 and FIG. 5, because objects in point cloud data acquired through a transportation means, such as a vehicle, have motion corresponding to the movement of the transportation means, it is likely that motion only in the X-axis and Y-axis directions is present. Accordingly, an occupancy map is generated based on the X-axis and the Y-axis, and the global motion is searched based thereon, whereby an efficient motion search may be possible with a low computational load.

Here, the global motion search based on the occupancy map may be performed as follows.

First, points in a point cloud frame are projected onto the XY plane, and an occupancy map may be generated by setting a value of 1 when a point is present at the corresponding location and by setting a value of 0 when no point is present at the corresponding location. Here, in order to lower the sensitivity of the occupancy map and to reduce the amount of data, the X-axis and the Y-axis may be scaled to specific sizes. Subsequently, based on the generated occupancy map, motion between the point cloud frames may be searched for. Here, an existing motion search method used in 2D images may be used for the search. Subsequently, the result of the motion search may be acquired in the form of a specific vector or a specific transform matrix, and the acquired vector or transform matrix may be used for point cloud motion compensation or local motion compression.

Also, in the method for compressing a point cloud based on global motion prediction and compensation according to an embodiment of the present invention, motion compression for the point cloud is performed at step S240 based on the result of the global motion search for each point cloud data segment.

Here, the global motion search result may be acquired so as to correspond to at least one of a motion vector and a motion transform matrix.

Here, using the global motion search result, local motion compression for the point cloud data may be performed.

For example, the motion of a point between the point cloud frames acquired using a sensor, such as LiDAR or the like, may be observed, and this motion may be categorized into local motion arising from the point itself and global motion caused due to movement of the device that is used to acquire the point cloud data.

Here, local motion compression for the point cloud data may be performed using existing G-PCC and point-cloud-based motion compression techniques.

Also, although not illustrated in FIG. 2, in the method for compressing a point cloud based on global motion prediction and compensation according to an embodiment of the present invention, motion compensation is performed for each point cloud data segment in consideration of local motion compression.

Here, the motion compensation may be aimed to increase compression efficiency by compensating the point cloud using the global motion search result.

For example, when local motion of the point cloud is compressed after the global motion is compensated for, the size of a locally generated motion vector may be reduced, and higher compression efficiency may be expected in spite of a small search range.

Accordingly, point cloud motion compensation may or may not be performed depending on the method of compressing the local motion of the point cloud, and in the case in which it is not performed, compression efficiency may be improved by directly using the global motion search result.

Here, motion information compression may be performed for the point cloud data.

Here, at least one of the point-cloud-cutting threshold value and the global motion search result may be compressed.

Here, based on the global motion search result, a residual motion information matrix between the point cloud frames is acquired, and the residual motion information matrix is entropy-encoded, whereby differential motion-information compression may be performed.

For example, point cloud frames acquired through a transportation means, such as a vehicle, represent continuous global motion depending on the movement of the vehicle, and global motion matrices may be similar across the frames due to this continuous motion. Also, point cloud frames pertaining to adjacent time points may represent information about similar objects, and the point-cloud-cutting threshold values generated based on information about the objects of the point cloud may be similar.

Accordingly, the residual value between the motion information of the previous frame and the motion information of the current frame may have a small positive or negative value due to the similarity of the motion information between the frames. When entropy-encoding algorithms, such as Huffman coding, arithmetic coding, and the like, are used based thereon, high compression efficiency may be achieved.

Also, although not illustrated in FIG. 2, in the method for compressing a point cloud based on global motion prediction and compensation according to an embodiment of the present invention, motion compression for the point cloud is performed in reverse order, whereby point cloud data is reconstructed.

That is, point cloud data segmentation, global motion compensation, local motion compression, motion information compression, and the like are performed in reverse order, whereby a compressed bitstream may be reconstructed to a point cloud.

Through the above-described method for compressing a point cloud based on global motion prediction and compensation, the compression ratio of point cloud content may be improved.

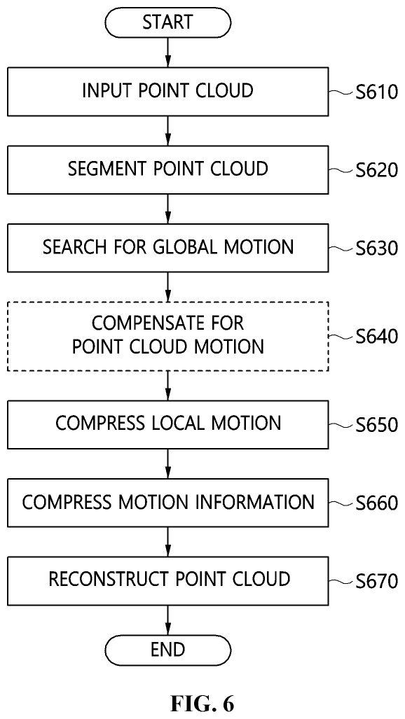

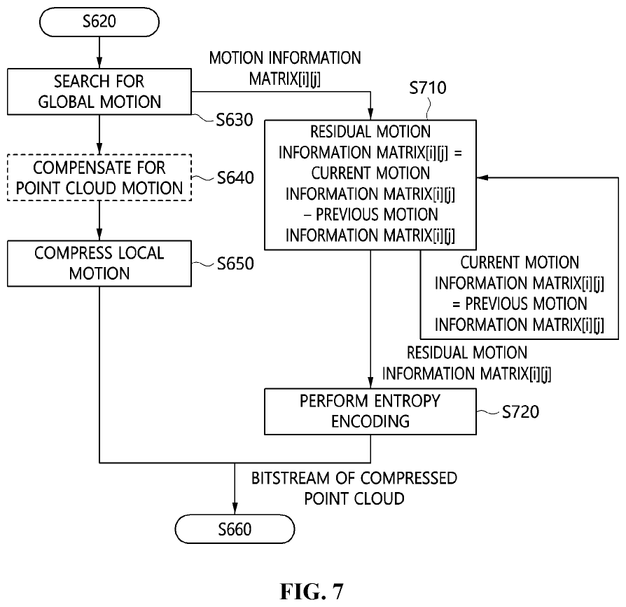

FIG. 6 is a flowchart illustrating in detail the process of compressing a point cloud according to the present invention, and FIG. 7 is a flowchart illustrating in detail an entropy-encoding-based compression process using a residual motion information matrix in the point cloud compression process illustrated in FIG. 6.

First, referring to FIG. 6, in the process of compressing a point cloud according to an embodiment of the present invention, first, 3D point cloud data configured with point cloud frames that represent continuous global motion may be input at step S610.

Subsequently, using a histogram generated based on the Z-axis of the point cloud data, the point cloud data may be segmented at step S620.

Subsequently, a global motion search based on an occupancy map may be performed for each point cloud data segment at step S630.

Subsequently, motion compensation may be performed for each point cloud data segment at step S640.

Subsequently, local motion compression may be performed for the point cloud data using the global motion search result at step S650.

Subsequently, motion information compression may be performed for the point cloud data at step S660.

Subsequently, motion compression for the point cloud data is performed in reverse order, whereby point cloud data may be reconstructed at step S670.

Here, after step S620, the residual motion information matrix between the point cloud frames may be acquired based on the global motion search result at step S710, as illustrated in FIG. 7.

Here, the residual motion information matrix may be acquired by subtracting the previous motion information matrix based on the previous frame from the current motion information matrix based on the current frame.

Subsequently, the residual motion information matrix is entropy-encoded at step S720, whereby differential motion-information compression may be performed.

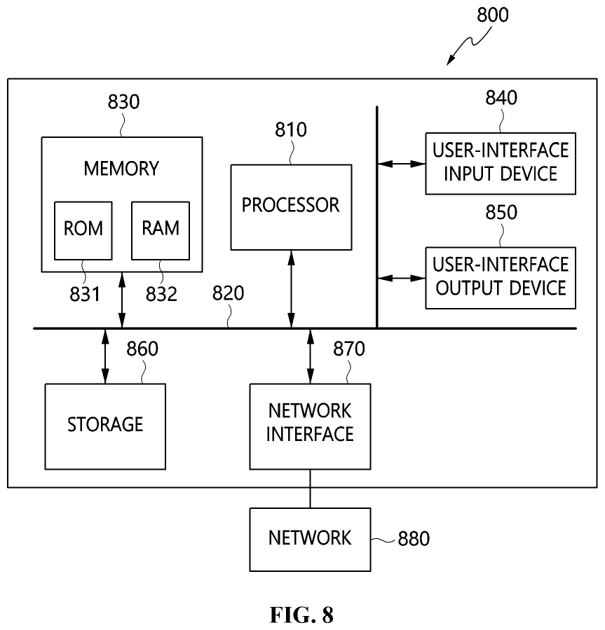

FIG. 8 is a block diagram illustrating an apparatus for compressing a point cloud based on global motion prediction and compensation according to an embodiment of the present invention.

Referring to FIG. 8, the apparatus for compressing a point cloud based on global motion prediction and compensation according to an embodiment of the present invention may be implemented so as to correspond to a computer system 800 including a computer-readable recording medium. As illustrated in FIG. 8, the computer system 800 may include one or more processors 810, memory 830, a user-interface input device 840, a user-interface output device 850, and storage 860, which communicate with each other via a bus 820. Also, the computer system 800 may further include a network interface 870 connected to a network 880. The processor 810 may be a central processing unit or a semiconductor device for executing processing instructions stored in the memory 830 or the storage 860. The memory 830 and the storage 860 may be any of various types of volatile or nonvolatile storage media. For example, the memory may include ROM 831 or RAM 832.

Accordingly, an embodiment of the present invention may be implemented as a non-transitory computer-readable storage medium in which methods implemented using a computer or instructions executable in a computer are recorded. When the computer-readable instructions are executed by a processor, the computer-readable instructions may perform a method according to at least one aspect of the present invention.

The processor 810 receives 3D point cloud data configured with point cloud frames that represent continuous global motion.

Also, the processor 810 segments the point cloud data using a histogram generated based on the Z-axis of the point cloud data.

Here, the highest Z value, indicating the largest number of points in the histogram, is detected, the gradients of the histogram are calculated from the highest Z value, and the point cloud data may be segmented based on a point-cloud-cutting threshold value at which gradient values equal to or less than a preset reference are continuous.

Also, the processor 810 performs a global motion search based on an occupancy map for each point cloud data segment.

Here, based on the point cloud frames, the points in the frame corresponding to the point cloud data segment may be projected onto the occupancy map based on the X-axis and the Y-axis.

Here, motion between the point cloud frames may be searched for based on the occupancy map.

Also, the processor 810 performs motion compression for the point cloud data based on the global motion search result for each point cloud data segment.

Here, the global motion search result may be acquired so as to correspond to at least one of a motion vector and a motion transform matrix.

Here, using the global motion search result, local motion compression for the point cloud data may be performed.

Also, the processor 810 performs motion compensation for each point cloud data segment in consideration of the local motion compression.

Here, the motion information for the point cloud data may be compressed.

Here, at least one of the point-cloud-cutting threshold value and the global motion search result may be compressed.

Here, a residual motion information matrix between the point cloud frames is acquired based on the global motion search result, and the residual motion information matrix is entropy-encoded, whereby differential motion-information compression may be performed.

Also, the processor 810 reconstructs point cloud data by performing motion compression for the point cloud data in reverse order.

The memory 830 stores the point cloud data.

Also, the memory 830 stores various kind of information generated in the above-described apparatus for compressing a point cloud according to an embodiment of the present invention.

According to an embodiment, the memory 830 may be separate from the apparatus for compressing a point cloud, and may support the function for compressing a point cloud. Here, the memory 830 may operate as separate mass storage, and may include a control function for performing operations.

Meanwhile, the apparatus for compressing a point cloud includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard-disk device, an optical disk device, or any other kind of mass storage device.

Using the above-described apparatus for compressing a point cloud based on global motion prediction and compensation, the compression ratio of the point cloud content may be improved.

According to the present invention, high-efficiency point cloud compression technology for performing point cloud data segmentation, a global motion search, motion compensation, and the like for input point cloud data may be presented.

Also, the present invention divides point cloud data acquired using a sensor, such as LiDAR or the like, into point cloud data segments depending on the characteristics thereof, searches for motion in the point cloud data segments, and compensates the point cloud data based on a found motion vector in 3D, thereby improving the compression ratio of the point cloud content.

As described above, the method for compressing a point cloud based on global motion prediction and compensation and the apparatus for the same according to the present invention are not limitedly applied to the configurations and operations of the above-described embodiments, but all or some of the embodiments may be selectively combined and configured, so that the embodiments may be modified in various ways.

What is claimed is:

1. A method for compressing a point cloud based on global motion prediction and compensation, comprising:
receiving 3D point cloud data configured with point cloud frames that represent continuous global motion;
dividing the point cloud data into point cloud data segments using a histogram generated based on a Z-axis of the point cloud data;
performing a global motion search based on an occupancy map for each of the point cloud data segments; and
performing motion compression for the point cloud data based on a result of the global motion search performed for each of the point cloud data segments.

2. The method of claim 1, wherein dividing the point cloud data into the point cloud data segments is configured to detect a highest Z value, indicative of a largest number of points in the histogram, to calculate gradients of the histogram from the highest Z value, and to divide the point cloud data based on a point-cloud-cutting threshold value at which gradient values equal to or less than a preset reference are continuous.

3. The method of claim 1, wherein performing the global motion search comprises:
based on the point cloud frames, projecting points in a frame, corresponding to the point cloud data segment, onto an occupancy map based on X and Y axes; and
searching for motion between the point cloud frames based on the occupancy map.

4. The method of claim 3, wherein the result of the global motion search is acquired so as to correspond to at least one of a motion vector and a motion transform matrix.

5. The method of claim 2, wherein performing the motion compression comprises:
performing local motion compression for the point cloud data using the result of the global motion search; and
performing motion information compression for the point cloud data.

6. The method of claim 5, wherein performing the motion information compression is configured to compress at least one of the point-cloud-cutting threshold value and the result of the global motion search.

7. The method of claim 6, wherein performing the motion information compression is configured to acquire a residual motion information matrix between the point cloud frames based on the result of the global motion search and to perform differential motion-information compression by entropy-encoding the residual motion information matrix.

8. The method of claim 5, further comprising:
performing motion compensation for each of the point cloud data segments in consideration of the local motion compression.

9. The method of claim 1, further comprising:
reconstructing point cloud data by performing motion compression for the point cloud data in reverse order.

10. An apparatus for compressing a point cloud based on global motion prediction and compensation, comprising:
a processor for receiving 3D point cloud data configured with point cloud frames that represent continuous global motion, dividing the point cloud data into point cloud data segments using a histogram generated based on a Z-axis of the point cloud data, performing a global motion search based on an occupancy map for each of the point cloud data segments, and performing motion compression for the point cloud data based on a result of the global motion search performed for each of the point cloud data segments; and
memory for storing the point cloud data.
